(19) United States
(12) Patent Application Publication
(10) Pub. No.: US 2002/0033634 A1
(43) Pub. Date: Mar. 21, 2002

(54) Motionless (non-rotating) vehicle wheel emblem, ornament, logo, trademark, sign, display or lettering

(76) Inventor: Joe Brown Ervin, Spring Hill, TN (US)

Correspondence Address: JOE ERVIN BROWN, 714 ELM STREET, SPRING HILL, TN, 37174-5609, US

(21) Appl. No.: 09/861,502

(22) Filed: May 21, 2001

Related U.S. Application Data
(60) Provisional application No. 60/156,533, filed on Sep. 29, 1999.

(51) Int. Cl. B60B 7/04

(52) U.S. Cl. 301/37.25

(57) ABSTRACT

A mechanical assembly, device or system which allows and facilitates the mounting or attaching of a desired logo, trademark, name, emblem, ornament, logo, trademark, sign, lettering or other display to a vehicle's wheels and remain motionless or in an upright position while the wheel, and/or wheel covering, rotates at its normal speed. The display (which is proportionately weighted) is mounted on a straight shaft (with a mounting surface) which is inserted at or through the center of the wheel or wheel covering and is supported by a ball bearing assembly affixed to the wheel or wheel covering (or cap) and properly weighted to prevent its rotation as the wheel, and/or wheel cover, rotates.

The undersigned has invented a new, original mechanical system, device and concept for vehicle wheel ornamentation and display which is titled “Motionless (non-rotating) Vehicle Wheel Emblem, Ornament, Logo, Trademark, Sign, Display or Leftering” of which the following is a specification. Reference is made to the accompanying drawings which form a part thereof, the figures of which are described as follows:

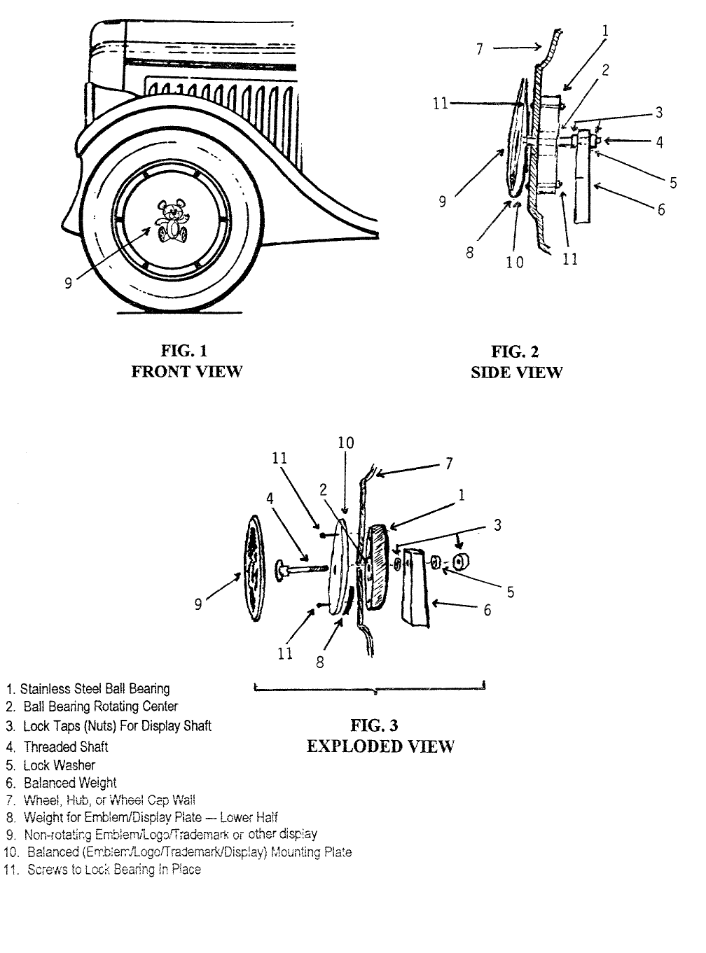

FIG. 1 is a FRONT view.

FIG. 2 is a SIDE view.

FIG. 3 is a EXPLODED view.

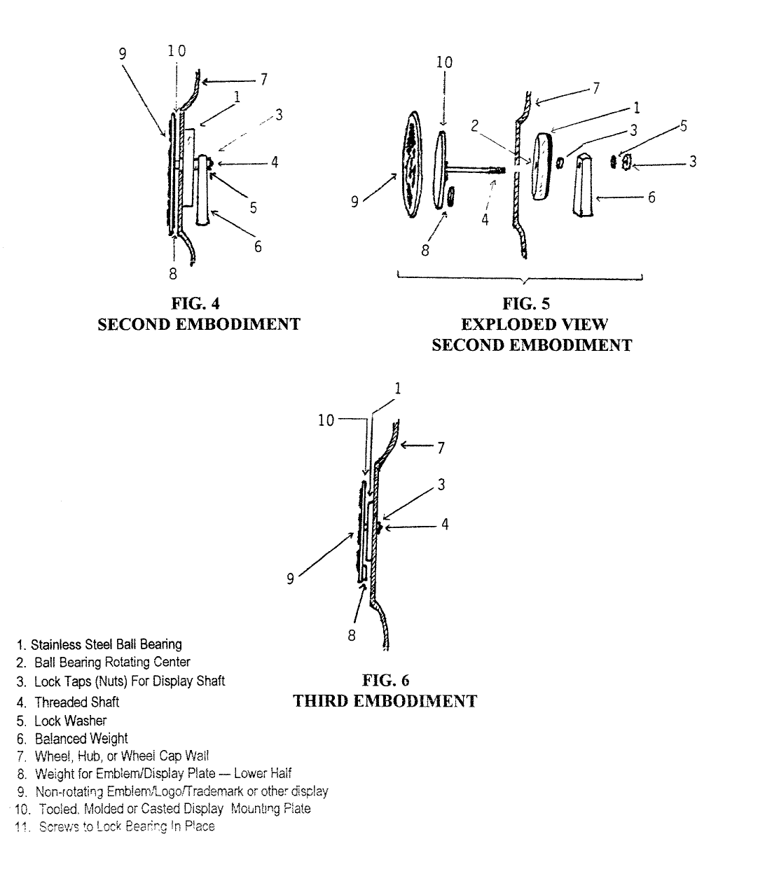

FIG. 4 is a SECOND EMBODIMENT view.

FIG. 5 is a EXPLODED 2ND EMBODM'T view.

FIG. 6 is a THIRD EMBODIMENT view.

The traditional vehicle wheel and wheel covering are designed so as to require all surfaces of the wheel or wheel cover to rotate with, and at the same speed of, the wheel. This invention allows and facilitates the mounting or attaching of a desired logo, trademark, name, emblem, ornament, logo, trademark, sign, lettering or other display which will remain motionless or in an upright position while the wheel, and/or wheel covering, rotates at its normal speed. (FIG. 1). The display (which is proportionately weighted) is mounted on a straight shaft (with a mounting surface) which is inserted at or through the center of the wheel or wheel covering and is supported by a ball bearing affixed to the wheel covering (or cap) and properly weighted to prevent its rotation as the wheel rotates. (FIG. 2). The shaft may, alternatively, be attached to the center (non-rotating extension) of the axle on vehicles which do not have a rotating axle at the wheel mount. If mounting of the display to the center of the axle is elected, a bearing may or may not be required depending on the distance from the point of attachment to the axle and the required or elected extension of the display beyond the rotating surfaces of the wheel or wheel cover. The length of the shaft upon which the display is mounted may be any length and may be a bolt, steel, molded, tooled and constructed of any material consistent with the desired durability and life of the display. In instances where a bearing is required, the bearing may be molded into the wheel or wheel covering or affixed to the wheel or wheel cover by weld, adhesive, or casting. (FIG. 5). If the wheel or wheel covering is retrofitted, the bearing must be affixed to the center of the wheel by weld, adhesive, or a screw mount. (FIG. 2); or a hole of sufficient diameter drilled in the center of the wheel cover or cap to allow the weighted shaft to spin freely. There is no limitation or restriction as to the size of the wheel or dimension of the display applicable to this invention. (FIG. 3 and FIG. 5). However, the display must be of a size, weight and dimension which will not interfere with the safe and normal functions and operations of the wheel to which the display is attached or upon which the display is mounted. This invention includes placement, by any means, of a series of letters or markings on a wheel or other rotating surface which will form a word, letter, picture or other desired image when the wheel, wheel cover, or other surface is rotated.

Claim: I claim ownership to a system of mechanical assembly, displays and devices which allows a logo, trademark, name, emblem, ornament, logo, trademark, sign, lettering or other display to be mounted in the center of a vehicle wheel or wheel cover (motorized or non-motorized) and remain virtually motionless, or in an upright position, while the wheel and its mounting hardware rotates. Specification: The undersigned has invented a new, original mechanical system, device and concept for vehicle wheel ornamentation and display which is titled “Motionless (non-rotating) Vehicle Wheel Emblem, Ornament, Logo, Trademark, Sign, Display or Lettering” of which the following is a specification. Reference is made to the accompanying drawings which form a part thereof, the figures of which are described as follows: FIG. 1 is a FRONT view. FIG. 2 is a SIDE view. FIG. 3 is a EXPLODED view. FIG. 4 is a SECOND EMBODIMENT view. FIG. 5 is a EXPLODED 2ND EMBODIM'T view. FIG. 6 is a THIRD EMBODIMENT view. The traditional vehicle wheel and wheel covering are designed so as to require all surfaces of the wheel or wheel cover to rotate with, and at the same speed of, the wheel. This invention allows and facilitates the mounting or attaching of a desired logo, trademark, name, emblem, ornament, logo, trademark, sign, lettering or other display which will remain motionless or in an upright position while the wheel, and/or wheel covering, rotates at its normal speed. (FIG. 1). The display (which is proportionately weighted) is mounted on a straight shaft (with a mounting surface) which is inserted at or through the center of the wheel or wheel covering and is supported by a ball bearing affixed to the wheel covering (or cap) and properly weighted to prevent its rotation as the wheel rotates. (FIG. 2). The shaft may, alternatively, be attached to the center (non-rotating extension) of the axle on vehicles which do not have a rotating axle at the wheel mount. If mounting of the display to the center of the axle is elected, a bearing may or may not be required depending on the distance from the point of attachment to the axle and the required or elected extension of the display beyond the rotating surfaces of the wheel or wheel cover. The length of the shaft upon which the display is mounted may be any length and may be a bolt, steel, molded, tooled and constructed of any material consistent with the desired durability and life of the display. In instances where a bearing is required, the bearing may be molded into the wheel or wheel covering or affixed to the wheel or wheel cover by weld, adhesive, or casting. (FIG. 5). If the wheel or wheel covering is retrofitted, the bearing must be affixed to the center of the wheel by weld, adhesive, or a screw mount (FIG. 2); or a hole of sufficient diameter drilled in the center of the wheel cover or cap to allow the weighted shaft to spin freely. There is no limitation or restriction as to the size of the wheel or dimension of the display applicable to this invention. (FIG. 3 and FIG. 5). However, the display must be of a size, weight and dimension which will not interfere with the safe and normal functions and operations of the wheel to which the display is attached or upon which the display is mounted. This invention includes placement, by any means, of a series of letters or markings on a wheel or other rotating surface which will form a word, letter, picture or other desired image when the wheel, wheel cover, or other surface is rotated.

1. I claim ownership to a system of mechanical assembly, displays and devices which allows a logo, trademark, name, emblem, ornament, logo, trademark, sign, lettering or other display to be mounted in the center of a vehicle wheel or wheel cover (motorized or non-motorized) and remain virtually motionless, or in an upright position, while the wheel, wheel cover, and its mounting hardware rotates.
